(19) United States
(12) Patent Application Publication
(10) Pub. No.: US 2012/0200165 A1
(43) Pub. Date: Aug. 9, 2012

(54) SWITCHING AN INDUCTIVE LOAD

(75) Inventor: Tarmo Känsälä, Tampere (FI)

(73) Assignee: ALSTOM GRID OY, Tampere (FI)

(21) Appl. No.: 13/500,050

(22) PCT Filed: Sep. 27, 2010
(86) PCT No.: PCT/FI2010/050742

§ 371 Date: Apr. 3, 2012

(30) Foreign Application Priority Data
Oct. 5, 2009 (FI) 20096017

(51) Int. Cl. H02J 4/00

(52) U.S. Cl. 307/99

(57) ABSTRACT

The invention relates to an arrangement and a method for switching an inductive load. Yet further the invention relates to a software product of a control system switching an inductive load. A semiconductor valve is used for switching an inductive load. The semiconductor valve comprises at least two semiconductor levels. A firing signal is supplied to the semiconductor valve. There is a determined delay between the firing signals of at least two semiconductor levels.

### FIELD OF THE INVENTION

The invention relates to an arrangement for switching an inductive load, which arrangement comprises a semiconductor valve arranged to switch an inductive load, the semiconductor valve comprising at least two semiconductor levels and means for supplying a firing signal to the semiconductor valve.

Further the invention relates to a method for switching an inductive load, in which method a semiconductor valve is controlled, the semiconductor valve comprising at least two semiconductor levels and in which method a firing signal is supplied to the semiconductor valve.

Yet further the invention relates to a software product of a control system switching an inductive load the control system comprising a control unit controlling a semiconductor valve comprising at least two semiconductor levels.

### BACKGROUND OF THE INVENTION

Thyristors are used in many high voltage applications. Because of the high voltage there is a need to use thyristor valves in which several thyristor levels are connected in series. Typically each thyristor level comprises a thyristor or two antiparallel-connected thyristors. Thyristor valves are used in static var compensators (SVC), where the thyristor valves are used in connection with thyristor-controlled reactors (TCR) and thyristor-switched capacitors (TSC), for example. Thyristor valves are also used in thyristor-controlled series capacitors (TCSC), which are used for compensating long transfer lines. Thyristor valves are also used in connection with high voltage direct current applications (HVDC).

Different capacitances, such as stray capacitance, distributed capacitance or the capacitance of the busbar structures etc., cause a very high current transient through the thyristor valve when the thyristor valve is turned on. If the transient current amplitude is high or the rise time of the current is fast, a so-called hot spot is formed in the thyristor and thus the thyristor is damaged. In prior art solutions saturable non linear di/dt limiting reactors or linear di/dt limiting reactors are installed in series with the valve for limiting the rate of the current rise. The reactors must match the voltage and current ratings of the valve and thus such a solution is complicated and expensive.

### BRIEF DESCRIPTION OF THE INVENTION

The arrangement of the invention is characterized in that the means for supplying the firing signal to the semiconductor valve is arranged to supply the firing signal to the semiconductor valve such that there is a determined delay between the firing signals of at least two semiconductor levels.

Further the method of the invention is characterized by supplying the firing signal to the semiconductor valve such that there is a determined delay between the firing signals of at least two semiconductor levels.

Yet further the software product of the invention is characterized in that the execution of the software product on the control unit is arranged to provide the following operations of supplying a firing signal to the semiconductor valve such that there is a determined delay between the firing signals of at least two semiconductor levels.

In the disclosed solution a semiconductor valve is used for switching an inductive load. The semiconductor valve comprises at least two semiconductor levels. A firing signal is supplied to the semiconductor valve such that there is a determined delay between the firing signals of at least two semiconductor levels. Because the semiconductor levels are not fired simultaneously, the discharge currents of the capacitances of the system are divided into several parts, whereby a high current pulse through the valve can be avoided. The semiconductor valve is turned on after the last semiconductor level is fired. Because of the inductive load the voltage of the semiconductor valve decreases all the time at each firing. Thus the final inrush current will decrease to a lower level. There is no need to use a di/dt limiting reactor or the size of the di/dt limiting reactor is moderate.

In an embodiment a capacitance (which can include the junction capacitance of the semiconductor(s)) across each semiconductor level is determined such that the voltage stress of each semiconductor level is only moderate. The capacitances of the system discharge into the capacitance of a fired semiconductor level in a controlled manner. Thus the voltage of a semiconductor level that has not yet been fired does not rise excessively. Further, because the voltage of the semiconductor valve decreases smoothly, the electromagnetic disturbances to other valves and to the environment are minimized.

### BRIEF DESCRIPTION OF THE DRAWINGS

In the following the invention will be described in greater detail by means of preferred embodiments with reference to the accompanying drawings, in which

FIG. 1 is a schematic of a thyristor-controlled reactor,

FIG. 2 shows the voltage of thyristor levels in a prior art solution,

FIG. 3 shows the thyristor valve current in a prior art solution,

FIG. 4 shows the voltage of the thyristor valve in a prior art solution,

FIG. 5 shows the voltages of thyristor levels in an embodiment using delayed firing,

FIG. 6 shows the thyristor valve current in an embodiment using delayed firing,

FIG. 7 shows the voltage of the thyristor valve in an embodiment using delayed firing,

FIG. 8 is a schematic view of an HVDC converter,

FIG. 9 is a schematic view of an HVDC thyristor valve,

FIG. 10 shows schematically an embodiment of supplying firing signals to thyristor levels and

FIG. 11 shows schematically yet another embodiment of supplying firing signals to thyristor levels.

### DETAILED DESCRIPTION OF THE INVENTION

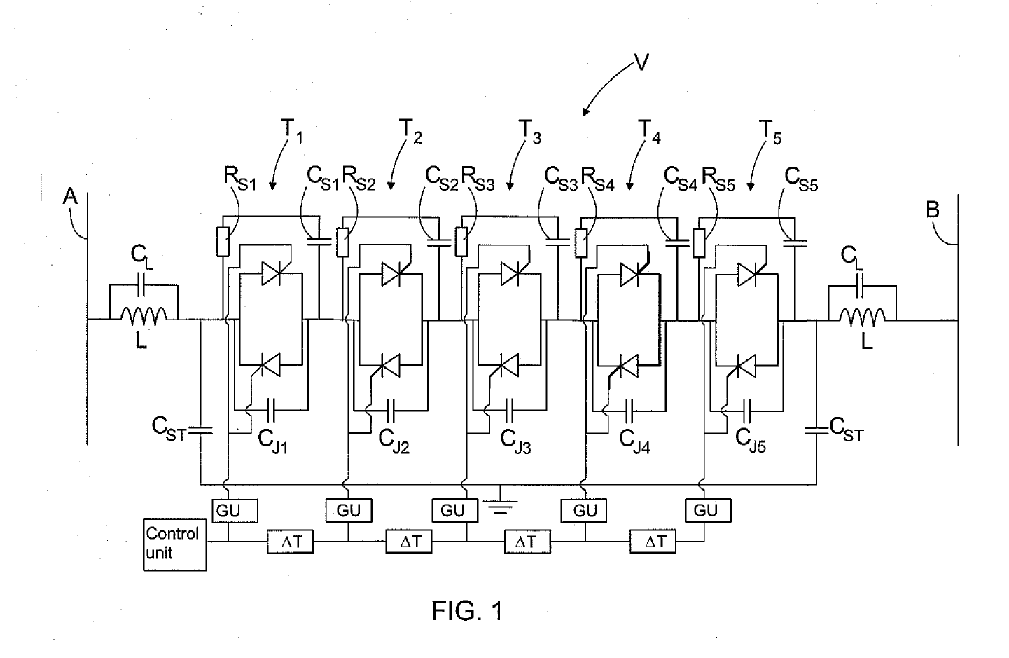

FIG. 1 shows a thyristor-controlled reactor that is arranged between phases A and B. The reactor L itself consists of two parts and the thyristor valve V is arranged between the reactor parts. The thyristor valve V comprises several thyristor levels T₁ to T₅ connected in series. Each thyristor level T₁ to T₅ comprises two antiparallel connected thyristors.

Several capacitances affect the system described in FIG. 1. Examples of these capacitances are stray capacitance, distributed capacitance and the capacitance of the busbar structures. In FIG. 1 these capacitances are represented by way of an example by the stray capacitance C_{ST} and the capacitances of the reactor C_{L}. Typically these capacitances are in the range of several hundreds of picofarads.

There is a snubber RC circuit across each thyristor level T₁ to T₅. Each snubber RC circuit consists of a snubber resistor R_{S1} to R_{S5} and of a snubber capacitor C_{S1} to C_{S5} connected in series.

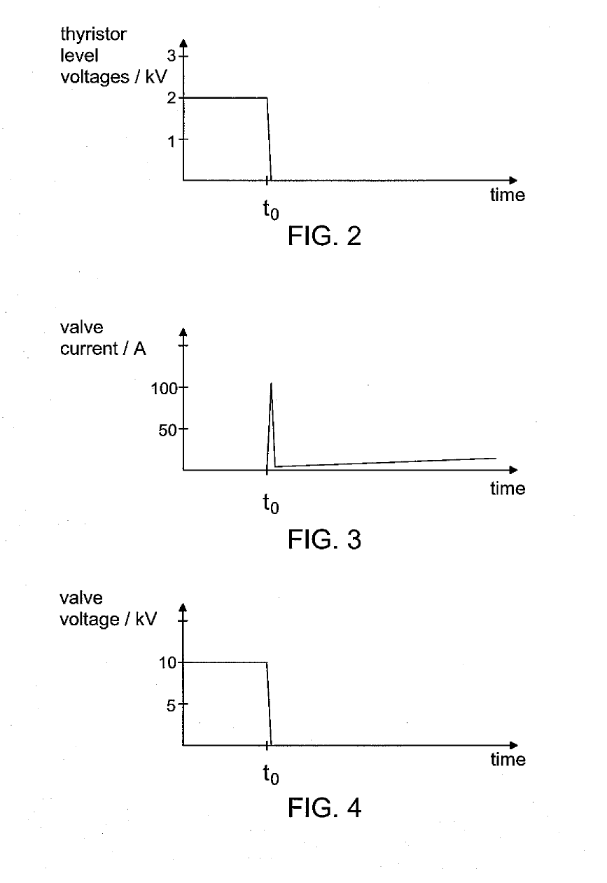

In prior art solutions the thyristor valve V is turned on such that each thyristor level T₁ to T₅ gets a firing signal simultaneously. FIGS. 2, 3 and 4 show what happens when the thyristor levels T₁ to T₅ are fired at the moment t₀. Thus the voltages of the thyristor levels drop from their nominal value to zero and also the voltage of thyristor valve drops from its nominal value to zero. The thyristor valve V is conducting and at the moment t₀ the capacitances of the system discharge through the thyristor valve and therefore there is a very high current peak as shown in FIG. 3. After this peak the current starts to rise depending on the inductive load. The voltage and current values shown in FIGS. 2, 3 and 4 only describe the magnitude of the values and their intention is not to be an exact example. Thus, typically the voltages are in the magnitude of several kilovolts and the height of the current peak can be in the magnitude of 100 amperes for example.

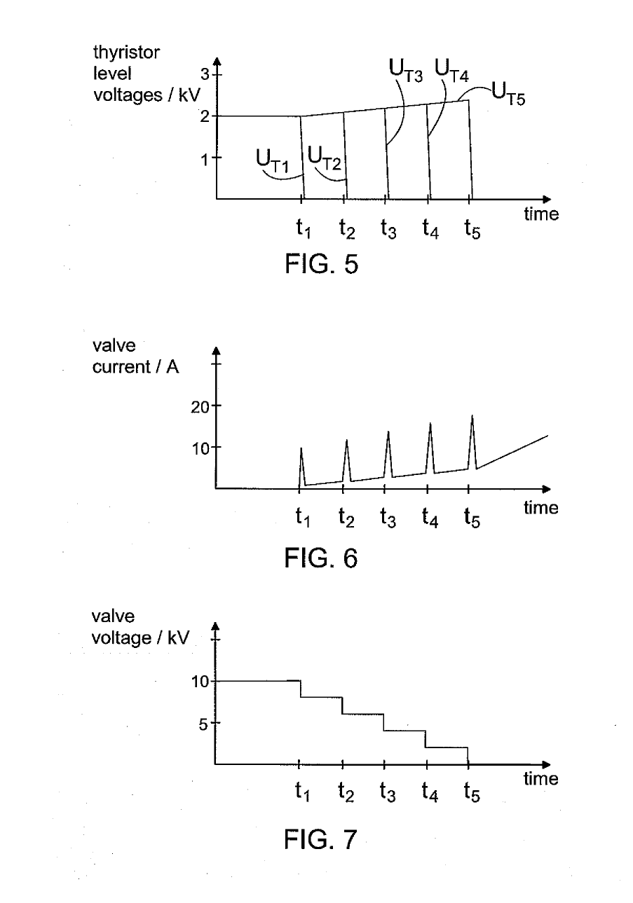

FIGS. 5, 6, and 7 describe what happens when there is a delay ΔT between the firing pulses of separate thyristor levels T₁ to T₅. The control unit shown in FIG. 1 supplies a firing signal to the gate unit GU of the thyristor level T₁ at the moment t₁. The voltage U_{T1} of the thyristor level T₁ drops from its nominal value to zero. Simultaneously the voltage of the thyristor valve V decreases as shown in FIG. 7. The valve V is not turned on totally but the current flows only through the first thyristor level T₁ and thereafter through the snubber circuits Rs₂Cs₂ to Rs₅Cs₅ and capacitances C_{J2} to C_{JS}, not through the thyristor levels T₂ to T₅. Therefore the current pulse of the thyristor valve is rather small. Typically the current pulse of the thyristor valve is about 10% of the current pulse caused by simultaneous firing as shown in FIG. 3. Because of the firing of the thyristor level T₁ the voltage of the thyristor valve decreases and the capacitances of the system discharge partly.

After a delay ΔT the firing signal is supplied to the gate unit GU of the second thyristor level T₂. Thus the thyristor level T₂ is fired at the moment t₂. The current pulse of the thyristor valve is also in this case rather low and this current pulse goes through the thyristor level T₁ that is already turned on and the snubber circuits Rs₃Cs₃ to Rs₅Cs₅ and capacitances to C_{J3} to C_{J5} of the levels that have not yet turned on. The thyristor level T₁ remains turned on because the current of the snubber RC circuit discharges with a time constant that is typically in the order of 100 μs. The voltage of the thyristor valve decreases also at the moment t₂.

The other remaining thyristor levels T₃ to T₅ are fired accordingly after a delay ΔT. When the last thyristor level T₅ is fired the thyristor valve is totally turned on and the current starts to rise according to the inductive load. Typically the firing sequence lasts 10 to 50 μs.

Voltages of the thyristor levels that are not yet fired rise to some extent. The rise is not, however, very significant, because each thyristor level has an internal capacitance that is called junction capacitance and shown in FIG. 1 with reference signs C_{J1} to C_{J5}. At each firing the junction capacitance of the fired thyristor discharges into the thyristor itself. The external stray capacitance discharges partly into the junction capacitances of the remaining un-fired thyristor levels. Thus the voltage of a un-fired thyristor level does not rise significantly.

Typically the junction capacitance of the thyristor level is several nanofarads. If the junction capacitances of the thyristor levels are not high enough, it is possible to arrange an auxiliary fast grading capacitance across the thyristor levels T₁ to T₅.

The delay between the firings can be for example 0.5 μs. The delay ΔT can vary between 0.2 μs to 5 μs, for example. If the delay ΔT is very short the capacitances of the system would discharge very fast and therefore their current peak through the thyristor valve would be rather high and therefore the system would be similar to the system with simultaneous firing of the thyristor levels. If the delay ΔT between the firings is rather long, the voltages of the thyristor levels that are not yet fired rise too much. Thus there would be a reasonably high voltage stress over the non-fired thyristor levels. Further, the total turn-on sequence must not be too long to keep the thyristor levels on. The firing angle of the thyristor can be continuously controlled after the voltage peak the firing angle varying between 90° and 180°, whereby the reactive power is controlled between 100% and 0%. If the firing angle is high, the voltage of the snubber capacitor C_{S} is low and thereby the discharging snubber current is low. Thus the delay ΔT must be short enough to keep also the first thyristor level T₁ and also all other fired thyristor levels turned on through the total firing or turn-on sequence.

The length of the delay ΔT between the firings can be equal between each level. It is also possible to vary the length of the delay ΔT between each or some of the firings.

Each thyristor level can pass the firing signal to a next thyristor level after the delay. In such an embodiment each thyristor level comprises appropriate components for making the delay to the firing signal. Thus the thyristor levels can be fired sequentially one after the other. It is also possible to fire some of the thyristor levels simultaneously. Thus, if the thyristor valve comprises 20 thyristor levels, the first and eleventh thyristor levels can be fired simultaneously and thereafter the second and twelfth etc, for example. It is also possible to fire the first three thyristor levels simultaneously and thereafter the fourth, fifth and sixth etc.

It is also possible to make the firing sequence more reliable such that firing commands are sent to two different thyristor levels in the valve and each gate unit GU passes the firing command onto both of its neighbours. The thyristor will, of course, only respond to the first firing command it receives.

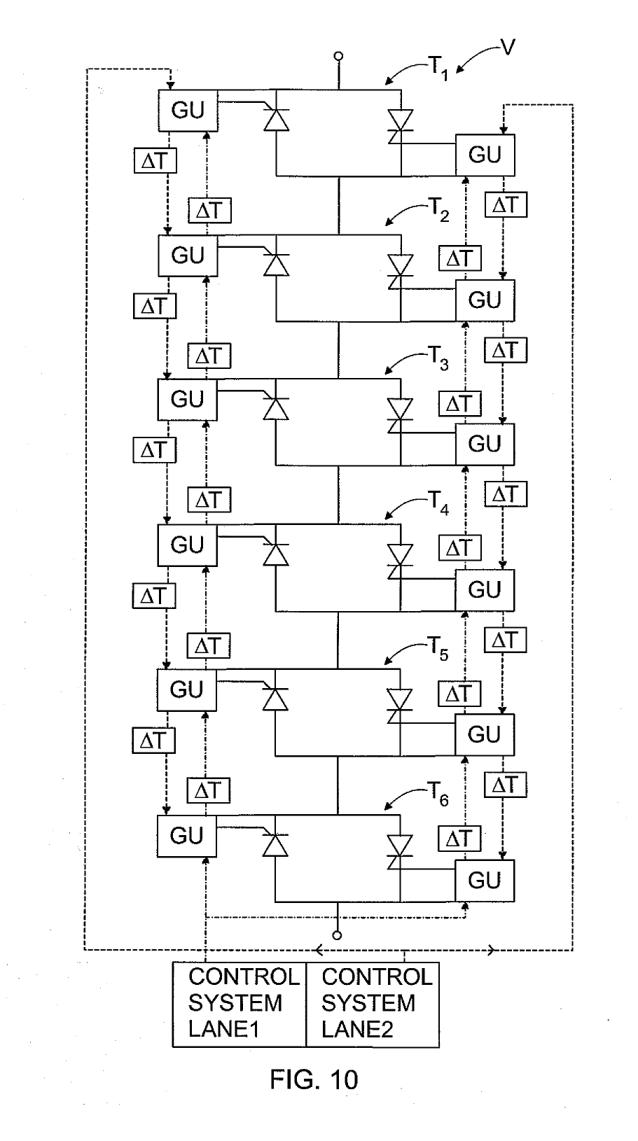

The firing supply can form a line as shown in FIG. 1 or the firing system can be arranged to form a ring. In the latter case some logic in the gate unit would be needed to ensure that firing commands are only passed on when the thyristor valve is off. These solutions ensure that the thyristor level is fired although one or more of the gate units are not healthy. An example of a dual redundant firing with a ring structure is shown in FIG. 10. In this embodiment the control system comprises two lanes for supplying the firing signal.

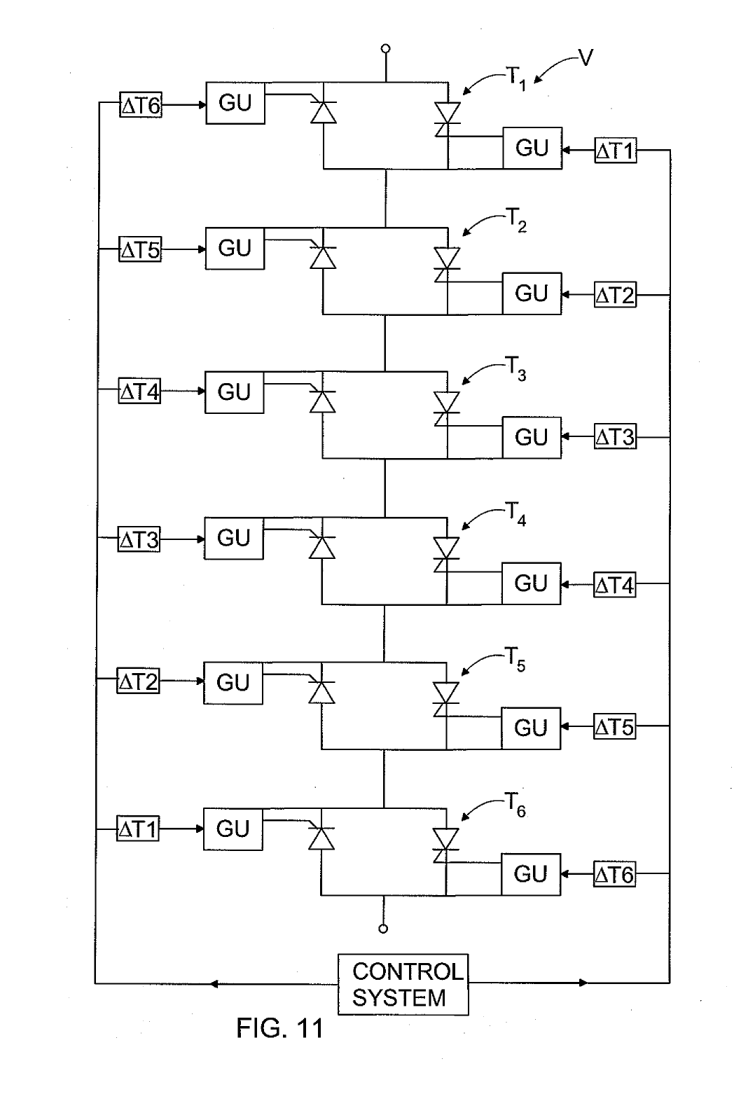

It is also possible to implement the firing delay centrally with a different variable delay for each thyristor level as shown in FIG. 11. This solution has a further advantage in that the duty on the different thyristors could be cycled so as to even out the thermal duty. Thus, the thermal loading of the thyristors can be averaged out. Thus, in this embodiment each delay ΔT₁ to ΔT₆ can have a different length. It is also possible to determine some of the delays to be equal in length. The control unit can comprise a software product whose execution on the control unit is arranged to provide the needed firing sequence. The software product can be loaded onto the control unit from a storage or memory medium, such as a memory stick, a memory disk, hard disk, a network server, or the like, the execution of which software product in the processor of the control unit or the like produces operations described in this specification for controlling a thyristor valve.

In FIG. 1 the thyristor-controlled reactor is shown between the phases A and B. Similar arrangements are also arranged between the other phases. Further, in practice the thyristor valve V typically comprises more than 5 thyristor levels T₁ to T₅. In practice the curves shown in FIGS. 2 to 7 are smoother. They describe the principle of the solution rather well, however.

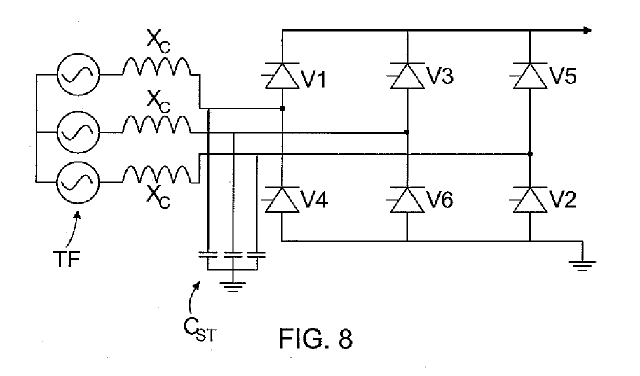

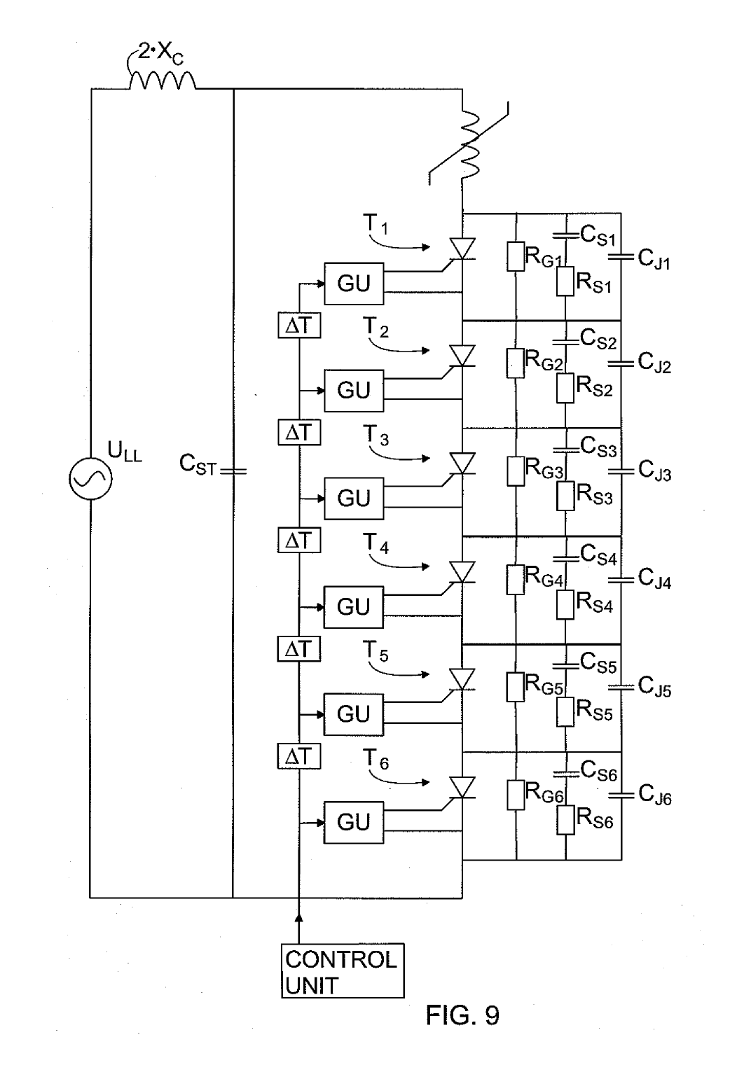

The arrangement is well suited for arrangement where the thyristor valve controls an inductive load. Thus the arrangement can also be applied to use in connection with high voltage direct current HVDC applications. An example of an HVDC application is explained below with reference to FIGS. 8 and 9.

FIG. 8 shows a schematic of an HVDC converter. An HVDC converter consists of six thyristor valves V₁ to V₆ in a bridge configuration. The valves are numbered in their standard firing sequence V₁—V₂—V₃—V₄—V₅—V₆.

The converter is connected to a converter transformer TF which has a substantial stray capacitance C_{ST} (typically of the order of 1 nF) due to its windings and bushings. The transformer TF has a leakage reactance which forms the inductive load of the converter, normally referred to as the commutating inductance X_{C}.

When a thyristor valve turns on, the stray capacitances C_{ST} due to the converter transformer TF and bushings discharge partially into the thyristor valve. This process is most severe and most easily understood on the valves V₂, V₄, V₆ which have one terminal earthed.

The problem described above is avoided or minimized by using the delayed firing described above. A schematic of a single HVDC thyristor valve is shown in FIG. 9. In this embodiment each thyristor level T₁ to T₆ comprises only a single thyristor instead of an antiparallel pair. FIG. 9 further shows the RC snubber circuits R_{S1}C_{S1} to R_{S6}C_{S6} and DC grading resistors R_{G1} to R_{G6}. The reference signs C_{J1} to C_{J6} denote the junction capacitance or, if fast grading capacitors are fitted in the arrangement, the combination of the junction capacitance and a fast grading capacitor.

The inductive load comprises two phases worth of commutating inductance being the inductance around the loop formed by the turning-on valve, turning-off valve and the converter transformer and is denoted in FIG. 9 by a reference sign 2·X_{c}. The instantaneous line to line voltage U_{LL} of the two affected phases equals U (line-line peak)·sin (alpha), where alpha is the firing angle. In normal operation, alpha can vary from around 15° in rectifier mode to around 150-160° in inverter mode.

When using the delayed firing described above, it is either possible to eliminate the di/dt limiting reactor or at least it is possible to make it smaller and lighter.

Instead of, or in addition to the thyristors mentioned in the specification with reference to FIGS. 1 and 11, the semiconductor levels may also comprise other components. Examples of these components are bidirectional thyristors, gate turn-off thyristors (GTO), integrated gate commutated thyristors (IGCT) and insulated gate-bipolar transistors (IGBT) or any other components suitable for the purpose. A semiconductor level can comprise a single component or two or more components. If a semiconductor level comprises two or more components, these components can be in parallel and/or antiparallel connection according to the need.

In some cases the features described in this application can be used as such regardless of other features. The features described in this application may also be combined, when necessary, to form various combinations.

It will be obvious to a person skilled in the art that, as the technology advances, the inventive concept can be implemented in various ways. The invention and its embodiments are not limited to the examples described above but may vary within the scope of the claims.

1. An arrangement for switching an inductive load, which arrangement comprises a semiconductor valve arranged to switch an inductive load, the semiconductor valve comprising at least two semiconductor levels and means for supplying a firing signal to the semiconductor valve, wherein the means for supplying the firing signal to the semiconductor valve is configured to supply the firing signal to the semiconductor valve such that there is a determined delay between the firing signals of at least two semiconductor levels.

2. An arrangement according to claim 1, wherein the length of the delay is between 0.2 μs to 5 μs.

3. An arrangement according to claim 1, wherein the arrangement comprises an auxiliary capacitor across each semiconductor level for preventing the voltage stress of a non-fired semiconductor level.

4. An arrangement according to claim 1, wherein the semiconductor level comprises at least one thyristor.

5. An arrangement according to claim 4, wherein the semiconductor level comprises at least two thyristors.

6. An arrangement according to claim 5, wherein at least two thyristors of the semiconductor level are in antiparallel connection.

7. A method for switching an inductive load, the method comprising controlling a semiconductor valve for switching the inductive load by supplying a firing signal to the semiconductor valve, the semiconductor valve comprising at least two semiconductor levels, and supplying the firing signal to the semiconductor valve such that there is a determined delay between the firing signals of at least two semiconductor levels.

8. A method according to claim 7, further comprising determining a capacitance across each semiconductor level and arranging an auxiliary capacitor across each semiconductor level if the voltage of a non-fired semiconductor level rises excessively because of delayed firing.

9. A method according to claim 7, wherein the length of the delay is between 0.2 μs to 5 μs.

10. A software product of a control system switching an inductive load the control system comprising a control unit controlling a thyristor valve comprising at least two semiconductor levels, wherein the execution of the software product on the control unit is configured to provide the following operations of supplying a firing signal to the semiconductor valve such that there is a determined delay between the firing signals of at least two semiconductor levels.
